(19) United States
(12) Patent Application Publication
(10) Pub. No.: US 2020/0193506 A1
(43) Pub. Date: Jun. 18, 2020

(54) SYSTEMS AND METHODS FOR GENERIC DIGITAL WALLET AND REMOTE ORDERING AND PAYMENT

(71) Applicant: JPMorgan Chase Bank, N.A., New York, NY (US)

(72) Inventors: Richard A. Hall, Marysville, OH (US); James P. White, III, Middletown, DE (US); Eric Han Kai Chang, Wilmington, DE (US); Scott H. Ouellette, Kingston, NH (US); Winter P. Ng, Lutz, FL (US); Howard Spector, Woolwich, NJ (US); Benjamin H. Sansom, Little Elm, TX (US); Erin Michelle Perry, Townsend, DE (US)

(21) Appl. No.: 16/223,744

(22) Filed: Dec. 18, 2018

(51) Int. Cl. G06Q 30/06; G06Q 30/02; G06Q 20/22; G06Q 20/24; G06Q 20/34

(52) U.S. Cl. CPC G06Q 30/0641; G06Q 30/0239; G06Q 20/34; G06Q 20/24; G06Q 20/227

(57) ABSTRACT

A system and method of storing purchase card information to enable a consumer to make purchases without carrying a separate purchase card for a plurality of accounts at disparate financial institutions. The system and method may additionally provide a consumer with vendor product and service offerings in a format common across multiple vendors. The system and method may also provide the consumer with a way to pay for products and services using purchase card information stored by an exemplary embodiment.

### BACKGROUND OF THE INVENTION

### 1. Field of the Invention

Embodiments are generally directed to systems and methods for generic digital wallet and remote ordering and payment.

### 2. Description of the Related Art

Known digital wallets permit credit/debit cards to be stored on a mobile device, but are incomplete and inefficient with regard to the user experience when using the stored cards. For instance, rewards programs, coupons and discount programs, and other store-specific programs may require the consumer to carry a rewards card, coupons, etc. on his or her person. If the consumer does not carry the rewards card, coupons, etc., the consumer may not be able to participate in the program.

Moreover, electronic payment for goods and services is generally siloed, such that goods or services from each vendor or provider are purchased with an application, method, or system that is specific to that vendor. Thus, a consumer must determine the method that is applicable for each vendor from which they wish to make a purchase. As a result, new or infrequent customers of these sites may have difficulty navigating through the various menus to order and pay for various goods and services.

### SUMMARY OF THE INVENTION

Systems and methods for generic digital wallet and remote ordering and payment are disclosed.

In an exemplary embodiment, a portal that aggregates information from a plurality of vendors such that a visitor to the portal is presented with a consistent interface for each of these vendors may be provided. In addition to the consistent interface, in certain exemplary embodiments, a user may be provided with a universal digital wallet that may be used to store and make purchases from different vendors and/or with a plurality of different purchase cards, such as credit cards, debit cards, etc.

In certain exemplary embodiments, the portal may provide the capability for a user to select from one or more vendors, to review and purchase goods or services from the selected vendor, and to pay for those purchases using a purchase card stored on the portal.

In certain exemplary embodiments, the portal may provide an interface such as an application program interface (API) that can be used by vendors to add information related to their products or services as well as pricing.

In certain exemplary embodiments, the portal may provide the billed amounts and selected purchase card information to a payment processing system that then handles the transfer of payments funds from a source (purchase card) to the recipient (vendor). In such an embodiment, the funds may be provided to the vendor in a manner similar to a person-to-person payment to avoid the requirement of the vendor having a payment receipt process.

In an exemplary embodiment, the portal may be provided on a user's mobile device in the form of a computer program or application (e.g., an “app”).

According to one embodiment, in a computer program executed by information processing apparatus comprising at least one computer processor, a method for facilitating orders from a consumer to a vendor may include: (1) receiving, from a plurality of vendors, product information comprising a plurality of products available from each vendor; (2) receiving, from the plurality of vendors, coupon or discount information applicable to at least one of the products; (3) generating a product menu for the product information; (4) presenting the product menu to a consumer; (5) receiving a selection of a product offered by one of the vendors from the product menu; (6) identifying a coupon or discount applicable to the product; (7) applying the coupon or discount to a price for the product; (8) identifying a purchase card for the price following application of the coupon or discount; and (9) conducting a transaction for the product.

In one embodiment, the step of conducting a transaction for the product may include sending the payment to the vendor associated with the selected product.

In one embodiment, the sent payment is sent using a different payment type from the payment card.

In one embodiment, the payment card may be a credit card, and the sent payment may be a check or an ACH transfer.

In one embodiment, the product menu that is presented to the consumer may be based on at least one prior purchase by the consumer.

In one embodiment, the product menu that is presented to the consumer may be based on a location of the information processing apparatus.

In one embodiment, the product menu that is presented to the consumer may be based on availability of the product.

In one embodiment, the coupon or discount may be automatically identified and applied to the price for the product.

In one embodiment, the method may further include associating a loyalty or reward account for the consumer with the transaction.

According to another embodiment, a system for facilitating orders from a consumer to a vendor may include a payment processing system hosted by a first electronic device comprising at least one computer processor; a vendor portal application hosted by a second electronic device comprising at least one computer processor; and a consumer electronic device comprising at least one computer processor and executing a consumer portal application and a mobile wallet application. The vendor portal may receive, from a plurality of vendors, product information comprising a plurality of products available from each vendor, and may receive, from the plurality of vendors, coupon or discount information applicable to at least one of the products. The consumer portal may receive a product menu for the product information, may present the product menu to a consumer, and may receive a selection of a product offered by one of the vendors from the product menu. The payment processing system may identify a coupon or discount applicable to the product, apply the coupon or discount to a price for the product, receive a purchase card for the price following application of the coupon or discount, and may conduct a transaction for the product.

In one embodiment, the payment processing system may conduct the transaction for the product by sending the payment to the vendor associated with the selected product.

In one embodiment, the sent payment may be sent using a different payment type from the payment card.

In one embodiment, the payment card may be a credit card, and the sent payment may be a check or an ACH transfer.

In one embodiment, the product menu that is presented to the consumer may be based on at least one prior purchase by the consumer.

In one embodiment, the product menu that is presented to the consumer may be based on a location of the information processing apparatus.

In one embodiment, the product menu that is presented to the consumer may be based on availability of the product.

In one embodiment, the coupon or discount may be automatically identified and applied to the price for the product.

In one embodiment, the payment processing system may associate a loyalty or reward account for the consumer with the transaction.

The above and other aspects and advantages of the general inventive concepts will become more readily apparent from the following description and figures, illustrating by way of example the principles of the general inventive concepts.

### BRIEF DESCRIPTION OF THE DRAWINGS

These and other features of the general inventive concept will become better understood with regard to the following description and accompanying drawings in which:

FIG. 1 is a diagram of a system for providing a universal ordering and payment system according to an exemplary embodiment; and

FIG. 2 is a diagram illustrating a method for using a universal ordering and payment system according to an exemplary embodiment of the invention.

### DETAILED DESCRIPTION OF PREFERRED EMBODIMENTS

Embodiments are generally directed to systems and methods for generic digital wallet and remote ordering and payment. For example, embodiments may leverage voice, sign language, etc. to remotely connect to external vendors and process orders and payments. Embodiments may use this with digital wallets and payment applications/services, such as ChasePay, Google Pay, Apply Pay, Samsung Pay, etc.

In embodiments, voice recognition, machine learning, camera movements, sensors, etc. may be used to process an order, send the data to a vendor, and receive feedback (e.g., confirmation of order, location of order, failures, etc.).

Embodiments may facilitate quick storage and retrieval of users' credit cards, loyalty program membership cards, car insurance, coupons, favorite meals, tickets (e.g., train, bus, airline, etc.), hotel check-in/check-out, restaurant waiting/queuing for tables/reservation, etc. and objects that may be stored in a centralized digital wallet that may be leveraged in a single transactions without requiring customer to multiple merchant or vendor applications installed on their devices or require merchants or vendor to provide one off solutions.

For example, in one embodiment, a customer using the digital wallet with a merchant or vendor may use stored coupons, a loyalty rewards program, etc., and may pay for products in a single transaction (e.g., NFC, etc.). Thus, embodiments eliminate or reduce the need for the customer to carry physical coupons, physical media on keyrings/keychains, etc., and improves the overall user experience.

Embodiments may leverage third party programs, such as Acorn, that allow users to “round up” payments and use the difference to deposit to a savings account, donate to charity, etc.

Embodiments may reduce the risk of information leakage for customers as data may be anonymized. Moreover, the data may be maintained in one location rather than duplicated and maintained in several locations. Embodiments may further integrate with third parties applications.

In embodiments, a portal may be provided to a consumer in the form of a computer program or application that may be executed by a mobile device. The application may be configured so that the consumer may select and purchase goods and services from various vendors and pay for those purchases using a selection of payment cards stored electronically on the mobile device.

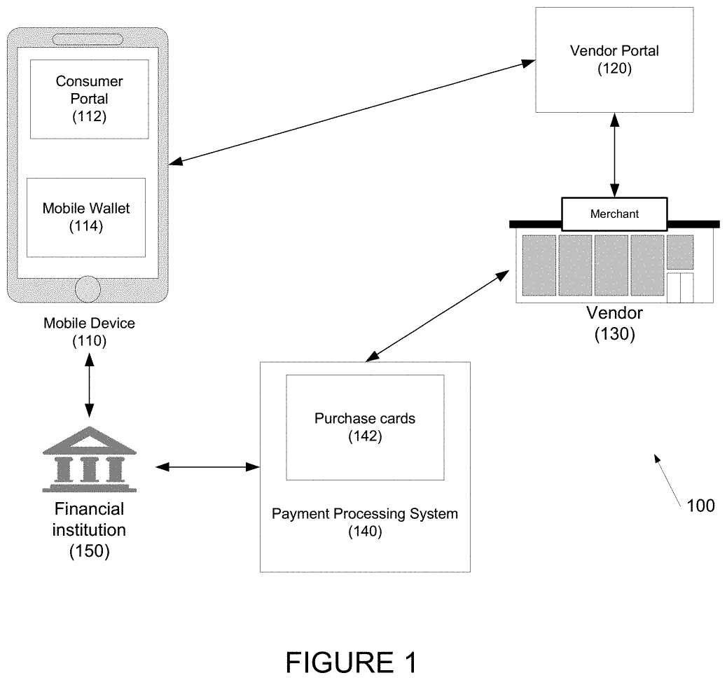

As shown illustrated in FIG. 1, an exemplary universal ordering and payment system 100 is disclosed. System 100 may include, for example, consumer portal 112 may be installed on mobile device 110 (e.g., smartphone, smart watch, tablet computer, laptop computer, Internet of Things (IoT) appliance, etc.). In one embodiment, consumer portal 112 may be a computer program or application.

In one embodiment, customer portal 112 may be installed, or used with, other devices, such as vehicles. In one embodiment, consumer portal 112 may be used with, or may be part of, a vehicle system (e.g., vehicle voice assistant software), etc. In one embodiment, customer portal 112 may leverage voice recognition software provided with other devices.

Consumer portal 112 may be in electronic communication with vendor portal 120. This communication may be enabled by a cellular data connection, a WiFi data connection, or other suitable electronic communication between mobile device 110 and a computer server or other computerized device that is equipped with software that forms vendor portal 120. Merchant or vendor portal 120 may include an interface that allows merchant or vendor 130 to electronically communicate with vendor portal 120. An example of a suitable interface is an application program interface (API). An API permits vendor 130 to connect to vendor portal 120 in order to exchange information with vendor portal 120.

In one embodiment, vendor portal 120 may include, or have access to, a database (not shown) for storing data.

For example, vendor 130 may be a restaurant or coffeehouse, and vendor 108 may connect to vendor portal 120 to provide information related to its goods or services. As another example, vendor 130 may be a pizza restaurant that may load a menu into vendor portal 120.

In one embodiment, the menu may be stored on vendor portal 120. In another embodiment, the menu may be provided to and stored on consumer portal 112.

In one embodiment, the menu may include pricing information that may be provided to payment processing system 140. Payment processing system 140 may receive payment information from the consumer, and may provide payment to vendor 130 in exchange for the goods or services ordered.

Payment processing system may store purchase card information 142 that may be associated with consumer portal 112. Purchase cards 142 may include debit cards, gift cards, credit cards, a checking account, debit account, third party payment providers, etc.

In one embodiment, when a consumer makes a purchase, the consumer may select one of purchase cards 142 to pay for the purchase. Payment processing system 140 may receive information identifying purchase card 142, or other source of funds, and may provide a request for payment to financial institution 150. Although the term “financial institution” is used herein, it should be understood that any source of funds, credits, gifts, vouchers, coupons or the like are contemplated by the invention. Examples of financial institution 150 include banks, aggregators, financial technology (FinTech) service providers, etc.

Financial institution 150 may authorize the transaction, and may provide the requested funds to payment processing system 140. In other exemplary embodiments, the funds may be provided directly to vendor 130.

In one embodiment, programs that are not specific to a particular vendor or a particular payment card may be stored in payment processing system 140. For instance, if the consumer wishes to participate in a charitable giving program in which all purchases are rounded up to the next dollar with the rounded amount being diverted to a charity or other organization, the logic for achieving the result may be stored in payment processing system 140. Accordingly, if a consumer makes a purchase for $50.75, $51.00 will be provided by purchase card 142 with the $0.25 excess amount being provided to a charity and the $50.75 purchase amount being provided to the vendor.

Vendor-specific information may be maintained by consumer portal 112 or payment processing system 140. For example, vendor 140 may make a coupon or discount code available to a consumer. This coupon or discount code may be presented to the consumer by consumer portal 112 in order encourage or reward consumer behavior desired by vendor 130. Consumer portal 112 may present the discounts and/or coupons available to the consumer using a screen (not shown).

In one embodiment, coupon(s) or discount code(s) may be automatically applied to a transaction as is necessary and/or desired without consumer interaction. The consumer may receive a notification (e.g., an in-app notification, push notification, email, SMS message, etc.) that the coupon or discount code is being applied, and the amount that was saved.

Similarly, the consumer's loyalty information may be stored and may automatically applied to a transaction. Any coupons, discounts, promotions, etc. that are associated with the loyalty program, the consumer's account, etc. may be automatically applied, or may be applied following confirmation.

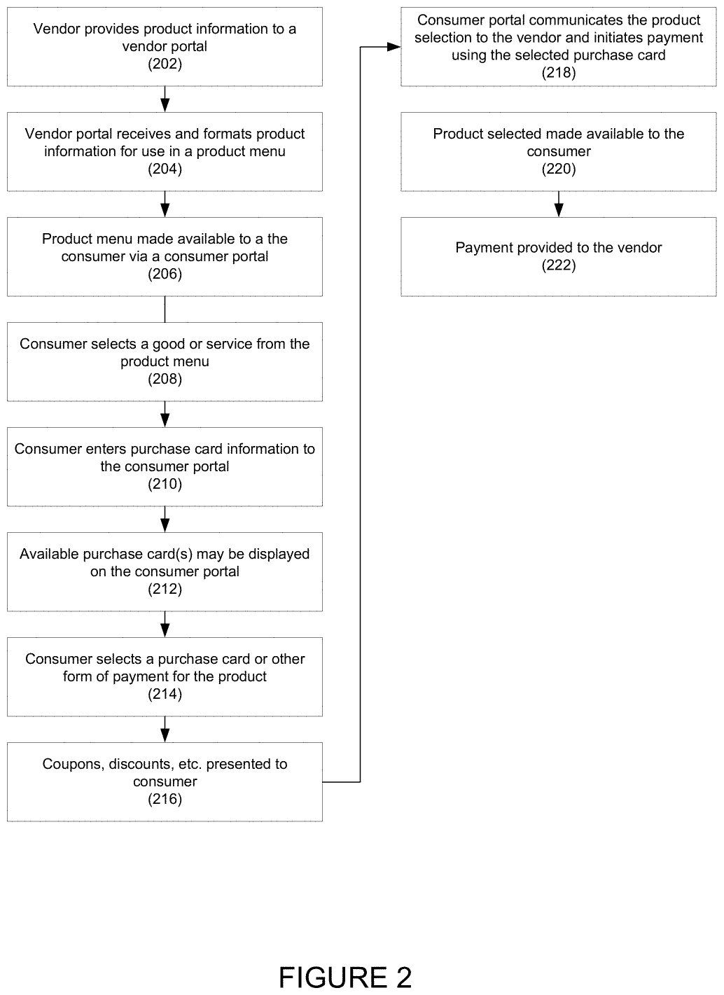

Referring to FIG. 2, a flowchart depicting a method for selecting a product and paying for the product is disclosed according to an exemplary embodiment. In step 202, a vendor may provide product information to a vendor portal. In one embodiment, the vendor may connect to an API that allows access to a product database; in another embodiment, the vendor may access the vendor portal using a web page, file transfer using file transfer protocol (FTP), email, batch transfer methods, etc.

In step 204, the vendor portal may receive the product information provided by the vendor, and may format the information for use in a product menu. In one embodiment, the product menu may be created or modified to include the provided product information.

In one embodiment, the vendor menu may be standardized such that menus from similar vendors may have a common appearance to facilitate the navigation when ordering. For example, one or more templates may be provided for use with certain products (e.g., for a pizza restaurant, a template may have categories for food, appetizers, salads, soups, and beverages). The vendor may be prompted to enter its offerings into vendor portal by category. Thus, the consumer portal may present the entered items in a form that is common to those of other vendors which also entered their offerings.

In addition, the vendor may upload discounts, coupons, and any other incentives using, for example, the vendor portal, and may specify expiration dates and/or limitations on the use of the discounts or coupons. The vendor may further identify or select restrictions and limitations from a menu, or may upload the restrictions and limitations using a predetermined data format that comprises the discounts, coupons, and other incentives as well the restrictions and limitations.

In step 206, the product menu may be made available to a the consumer via a consumer portal. This consumer portal may be a web page, a computer program or software application running on a mobile device, a menu on an automated teller machine, IoT device, or other kiosk device.

In one embodiment, the consumer portal may be made available through a financial institution's payment application that may facilitate the ordering and payment process. In another embodiment, the consumer portal may be linked to the financial institution's payment application, mobile application, electronic wallet, etc. Such incorporation or linking may simplify the process or selecting a product and paying for the product.

In step 208, a consumer may select one or more products from the product menu. In one embodiment, the consumer may search for a product directly, and may make a selection from the product menu without the necessity of the consumer portal displaying the product menu. In another embodiment, the products may be presented using displays that are not product menus, such as in groups based on functionality or purpose.

In another embodiment, machine learning may be used to present possible products for the consumer based on, for example, prior purchases. For example, if the consumer usually purchases coffee from a particular vendor every morning, the consumer may be presented with a staged transaction to purchase coffee.

In one embodiment, the vendors presented may be based on a location of the consumer's electronic device. Thus, if the consumer is searching for food, the vendors may be organized by distance, type of food, recommendations and/or ratings of others, etc.

In one embodiment, the vendors may be presented based on product availability. For example, if the vendor is experiencing delays, the vendor may be lowered in the presentation, an indicator of such may be presented to the consumer, etc.

In one embodiment, interaction with the consumer portal may be conducted using voice recognition technology.

In step 210, a consumer may enter purchase card information to the consumer portal. For example, the information might include a card number, expiration date, the consumer's address, CVV code, bank account identifier, gift card number, third party payment provider information, etc. This step may be performed prior to the consumer viewing and selecting products.

In another embodiment, the consumer's purchase card information may be provided by a host payment application, such as a financial institution's payment application. In another embodiment, the purchase card information may be provided from a linked digital wallet.

In one embodiment, the purchase card information may be entered during a registration process.

In step 212, the available purchase card(s) may be displayed or otherwise presented on the consumer portal. This display may be in the form of a list of payment methods or similar way of communicating the available forms of payment.

In step 214, the consumer may select a purchase card or other form of payment with which to pay for the selected product. In one embodiment, a default purchase card may be selected and used.

In step 216, the consumer may be presented with any available coupons, discounts, promotions, etc. For example, the consumer may be presented with coupon, discount code, loyalty program information, etc., previously provided by the vendor and stored by consumer portal.

In one embodiment, the coupons, discounts, etc. may be associated with the use of a particular purchase card. Thus, if a consumer selects a particular purchase card for a transaction, discounts may be automatically applied to the purchase.

Coupons, discounts, etc. may also be presented to the consumer prior to their selection of a purchase card in order to encourage the use of a particular purchase card.

In one embodiment, coupon(s) or discount code(s) may be automatically applied to a transaction as is necessary and/or desired without consumer interaction. The consumer may receive a notification (e.g., an in-app notification, push notification, email, SMS message, etc.) that the coupon or discount code is being applied, and the amount that was saved.

Similarly, the consumer's loyalty information may be may automatically applied to a transaction. Any coupons, discounts, promotions, etc. that are associated with the loyalty program, the consumer's account, etc. may be automatically applied, or may be applied following confirmation.

In step 218, the consumer portal may communicate the product selection to the vendor and may initiate a payment using the selected purchase card (or other selected payment method) and any coupons, discount codes, and/or loyalty programs.

In one embodiment, the consumer portal may be used at a point-of-sale device to provide payment information to the vendor. For example, the consumer may select a purchase card for the transaction, and the consumer portal may provide the necessary payment information to vendor by, for example, near field communication. In one embodiment, a code or other mechanism may be used to securely transfer the payment information to the vendor.

In another embodiment, the transaction may be conducted over the Internet, remote from the vendor's physical location.

In step 220, the product selected may be made available to the consumer. This might be in the form of an actual delivery, an electronic delivery, an in-person purchase, or other means of conveying or providing the product to the consumer.

In step 222, payment may be provided to the vendor. This may be in the form of a funds transfer, check, or similar method of providing funds from the consumer to the vendor. This payment may be provided directly from the consumer portal, from the vendor portal, or from a payment processing system as described elsewhere herein.

In one embodiment, the payment to the vendor may be in a different form than the purchase card. For example, if the vendor does not support on-line credit card purchases, the financial institution may charge the purchase card, but may make the payment to the vendor in the form of a check, ACH transfer, etc. Because different payment mechanisms may be used, the vendor may not be required to have additional infrastructure (e.g., credit card payment systems) in order to conduct transactions.

It should be noted that although several embodiments may have been disclosed, these embodiments are not exclusive. Features from one embodiment may be applied to others as is necessary and/or desired.

While the present invention and associated inventive concepts have been illustrated by the description of various embodiments thereof, and while these embodiments have been described in considerable detail, it is not the intention of the Applicant to restrict or in any way limit the scope of current or future claims to such detail. Additional advantages and modifications will readily appear to those skilled in the art. Moreover, in some instances, elements described with one embodiment may be readily adapted for use with other embodiments. Therefore, the invention, in its broader aspects, is not limited to the specific details, the representative apparatus, and illustrative examples shown and described. Accordingly, departures may be made from such details without departing from the spirit or scope of the general inventive concepts.

What is claimed is:

1. A method for facilitating orders from a consumer to a vendor comprising:
in a computer program executed by information processing apparatus comprising at least one computer processor:
receiving, from a plurality of vendors, product information comprising a plurality of products available from each vendor;
receiving, from the plurality of vendors, coupon or discount information applicable to at least one of the products;
generating a product menu for the product information;
presenting the product menu to a consumer;
receiving a selection of a product offered by one of the vendors from the product menu;
identifying a coupon or discount applicable to the product;
applying the coupon or discount to a price for the product;
identifying a purchase card for the price following application of the coupon or discount; and
conducting a transaction for the product.

2. The method of claim 1, wherein the step of conducting a transaction for the product comprises:
sending the payment to the vendor associated with the selected product.

3. The method of claim 2, wherein the sent payment is sent using a different payment type from the payment card.

4. The method of claim 3, wherein the payment card is a credit card, and the sent payment is a check or an ACH transfer.

5. The method of claim 1, wherein the product menu that is presented to the consumer is based on at least one prior purchase by the consumer.

6. The method of claim 1, wherein the product menu that is presented to the consumer is based on a location of the information processing apparatus.

7. The method of claim 1, wherein the product menu that is presented to the consumer is based on availability of the product.

8. The method of claim 1, wherein the coupon or discount is automatically identified and applied to the price for the product.

9. The method of claim 1, further comprising:
associating a loyalty or reward account for the consumer with the transaction.

10. A system for facilitating orders from a consumer to a vendor, the system comprising:
a payment processing system hosted by a first electronic device comprising at least one computer processor;
a vendor portal application hosted by a second electronic device comprising at least one computer processor; and
a consumer electronic device comprising at least one computer processor and executing a consumer portal application and a mobile wallet application;
wherein:
the vendor portal receives, from a plurality of vendors, product information comprising a plurality of products available from each vendor;
the vendor portal receives, from the plurality of vendors, coupon or discount information applicable to at least one of the products;
the consumer portal receives a product menu for the product information;
the consumer portal presents the product menu to a consumer;
the consumer portal receives a selection of a product offered by one of the vendors from the product menu;
the payment processing system identifies a coupon or discount applicable to the product;
the payment processing system applies the coupon or discount to a price for the product;
the consumer portal receives a purchase card for the price following application of the coupon or discount; and
the payment processing system conducts a transaction for the product.

11. The system of claim 10, wherein the payment processing system conducts the transaction for the product by sending the payment to the vendor associated with the selected product.

12. The system of claim 11, wherein the sent payment is sent using a different payment type from the payment card.

13. The system of claim 12, wherein the payment card is a credit card, and the sent payment is a check or an ACH transfer.

14. The system of claim 1, wherein the product menu that is presented to the consumer is based on at least one prior purchase by the consumer.

15. The system of claim 1, wherein the product menu that is presented to the consumer is based on a location of the information processing apparatus.

16. The system of claim 1, wherein the product menu that is presented to the consumer is based on availability of the product.

17. The system of claim 1, wherein the coupon or discount is automatically identified and applied to the price for the product.

18. The system of claim 1, wherein the payment processing system associates a loyalty or reward account for the consumer with the transaction.
